(19) United States
(12) Patent Application Publication
(10) Pub. No.: US 2022/0335457 A1
(43) Pub. Date: Oct. 20, 2022

(54) SURVEY PANELIST UTILIZATION

(71) Applicant: Lightspeed, LLC, Bridgewater, NJ (US)

(72) Inventors: Mitch Eggers, Seattle, WA (US); Gerald Liedtke, Leander, TX (US); Marc Ryan, Darien, CT (US); Mark Varelia Milodragovich, Seattle, WA (US); Chris Stevens, Liphook (GB); Flora Montufar, Sherman Oaks, CA (US)

(21) Appl. No.: 17/715,801

(22) Filed: Apr. 7, 2022

Related U.S. Application Data
(60) Provisional application No. 63/172,506, filed on Apr. 8, 2021.

(51) Int. Cl. G06Q 30/02

(52) U.S. Cl. CPC G06Q 30/0203; G06Q 30/0201; G06Q 30/0205

(57) ABSTRACT

A facility for assembling a list of survey qualification questions to present to a person is described. The facility first initializes the list to be empty. The facility adds to the initialized list a survey qualification question for a survey elected by the person. Until the list reaches a predetermined size, repeats the following: for each of a group of candidate survey qualification questions, for each of the survey qualification questions on the list, the facility determines an asymmetric overlap score for the candidate survey qualification question with the survey qualification question on the list; among the determined asymmetric overlap scores, the facility determining a lowest one, and moves one or more survey qualification questions from the group of candidate survey qualification questions to the list.

### CROSS-REFERENCE TO RELATED APPLICATION

This application claims the benefit of provisional U.S. Application No. 63/172,506, filed Apr. 8, 2021 and entitled “IMPROVED SURVEY ADMINISTRATION,” which is hereby incorporated by reference in its entirety. In cases where a document incorporated herein by reference conflicts with the present disclosure, the present disclosure controls.

### BACKGROUND

Market research surveys collect feedback from the target audience for a product or service to understand their characteristics, expectations, and requirements.

It is common for companies that have a product or service in the market or are considering launching one to (1) prepare a sequence of questions soliciting audience feedback that constitutes the survey; (2) specify conditions a respondent must satisfy in order to be able to take the survey and have their responses to its questions included in the survey result; and (3) engage one or more market survey platforms to administer the survey to respondents who satisfy the conditions, and report the results.

Market research platforms typically accept surveys from multiple clients. The platforms assemble pools of people (a panel) who are interested in taking market research surveys—often in exchange for compensation in various forms—and provide a web interface and/or mobile app interface in which all members can select and take surveys relating to different products and services from different clients of the platform.

In particular, it is common for these platform interfaces to display a number of in-process surveys to a panel member; receive the panel member's selection of one of the displayed surveys; pose one or more qualification questions as a basis for determining whether the panel member satisfies the conditions specified for the selected survey; if the panel member satisfies the selected survey's conditions, present the survey to the panel member for completion; and include the panel member's responses to the selected survey in the survey result.

### BRIEF DESCRIPTION OF THE DRAWINGS

FIG. 1 is a network diagram showing a sample environment in which the facility operates in some embodiments.

FIG. 2 is a block diagram showing some of the components typically incorporated in at least some of the computer systems and other devices on which the facility operates.

FIG. 3 is a flow diagram showing a process performed by the facility in some embodiments to administer surveys to a panel member.

FIGS. 4A and 4B are table diagrams showing sample contents of a survey table used by the facility in some embodiments used to store information about active surveys placed on the survey platform.

FIG. 5 is a table diagram showing sample contents of a user survey exclusion table used by the facility in some embodiments to identify surveys from which particular panel members are excluded.

FIG. 6 is a display diagram showing a sample display presented by the facility in some embodiments to permit a panel member to select an available, unexcluded survey.

FIG. 7 is a flow diagram showing a process performed by the facility in some embodiments to construct a set of qualifications based upon a particular panel member's selection of a particular survey.

FIG. 8 is a flow diagram showing a process performed by the facility in some embodiments to identify the qualification question in the candidate group having the lowest asymmetric overlap score with the qualification questions already in the list.

FIG. 9 is a Venn diagram showing all possible patterns of interaction of panel members with qualification questions Qx and Qy.

FIG. 10 is a table diagram showing initial sample contents of a qualification question result table used by the facility in some embodiments to store the results of administering particular qualification questions to particular audience members.

FIG. 11 is a table diagram showing subsequent sample contents of the qualification question result table.

FIG. 12 is a table diagram showing subsequent sample contents of the user survey exclusion table, as updated to reflect qualification questions answered incorrectly by the panel member in the example.

FIG. 13 is a table diagram showing subsequent sample contents of the user survey exclusion table, updated to exclude the administered survey for the panel member in the example.

FIG. 14 is a display diagram showing subsequent sample contents of the display presented by the facility to permit a panel member to select an available, unexcluded survey.

### DETAILED DESCRIPTION

The inventors have identified significant disadvantages of conventional approaches to administering market research surveys (“surveys”) in market research platforms (“platforms”). Specifically, the inventors have recognized that these conventional approaches make inefficient use of panel members' time, and are often frustrating to panel members, in some cases causing them to resign or otherwise disengage from the panel. This is because, under the conventional approach, a panel member may have to repeat the following set of steps a number of times before they are able to take a survey: (1) review a list of available surveys; (2) select one of the listed surveys; (3) answer qualification questions for the selected survey; and (4) learn that they did not satisfy the survey's conditions, and must select another survey.

In response to recognizing these disadvantages, the inventors have conceived and reduced to practice a software and/or hardware facility for improved survey administration (“the facility”). When a panel member selects a survey from a list of available surveys, the facility constructs a set of qualification questions to present to the user. Each qualification question in the set corresponds to a different survey and serves as a basis for determining whether the panel member is qualified to take the survey. One of the questions corresponds to the survey selected by the user. The facility selects the other questions based on factors that include (1) disfavoring questions correctly answered at a high rate by panel members that have correctly answered questions already included, especially where a large number of users have answered both, and (2) favoring earlier target dates for finishing the surveys or other business considerations among surveys. Selecting qualification questions for the set that have low correlation in accordance with the first of these two factors is referred to herein as “asymmetric overlap analysis.” If the panel member answers the question for the selected survey correctly, the facility administers the selected survey to them. If they do not, but answer questions for one or more other surveys correctly, the facility administers one of these other surveys to them.

In some embodiments, the facility maintains a list of surveys that it presents to each panel member for selection, which includes only a proper subset of all surveys available on the platform. In some embodiments, this list is of fixed size, such as 8 or 12 surveys. In some embodiments, in addition to removing from the list surveys taken by the panel member as they are completed, the facility also removes from the list surveys whose qualification questions the panel member has answered incorrectly. Each time a survey is removed from the list, the facility replaces it with another survey available on the platform that the panel member has not completed, nor answered the qualification question incorrectly.

By performing in some or all of the ways described above, the facility efficiently assigns panel members to the surveys they will qualified for and have a greater chance to complete. This assists with panel member retention and engagement because the panel member will be able to redeem rewards for completed surveys. The facility also provides a large measure of randomness in the assignment of surveys to panel members, providing fairness among different companies placing surveys on a platform. The facility also often improves the level at which business considerations of the platform's operator are satisfied.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by reducing the average number of interactions a user must make with a client computing system in order to begin taking each survey, the facility reduces the number of processing cycles consumed by this process on the client computing system, and, in some cases, on a server computing system supporting the operation of the client computing system.

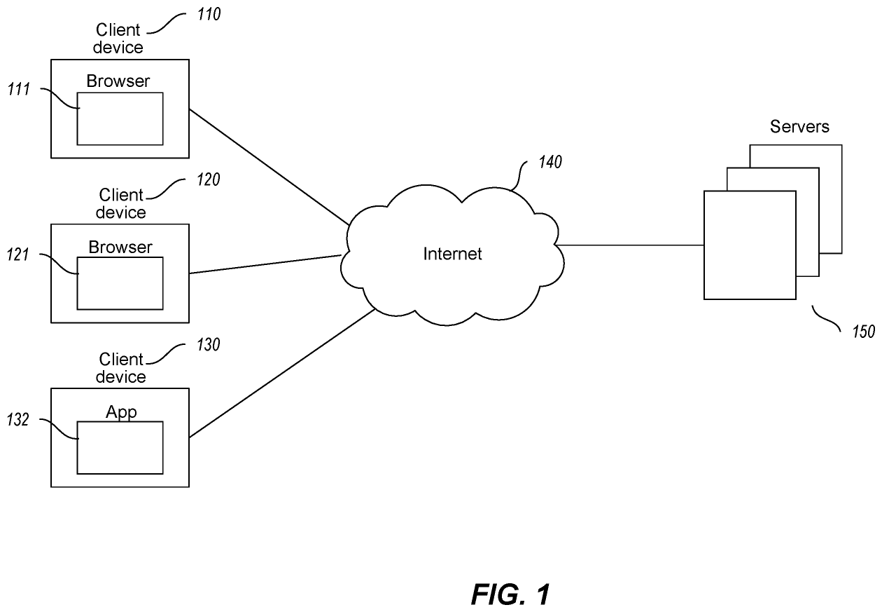

FIG. 1 is a network diagram showing a sample environment in which the facility operates in some embodiments. A number of client devices 110, 120, and 130 are connected via the Internet 140 or another network to one or more servers 150 that operate a survey platform. Some of the client devices—such as client device 110—execute a browser that interacts with the survey platform software on the server on behalf of a panel member using the client device, while other client devices—such as client device 130—execute a specialized mobile app or desktop application that interacts with the survey platforms software on the server on behalf of a panel member using the client device.

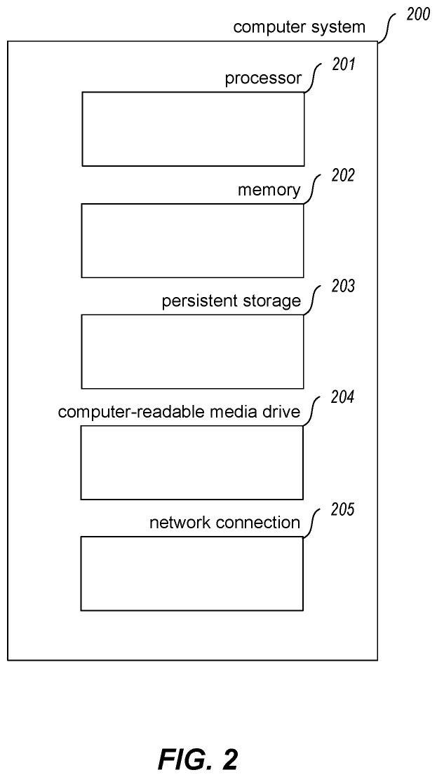

FIG. 2 is a block diagram showing some of the components typically incorporated in at least some of the computer systems and other devices on which the facility operates, including the devices shown in FIG. 1. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

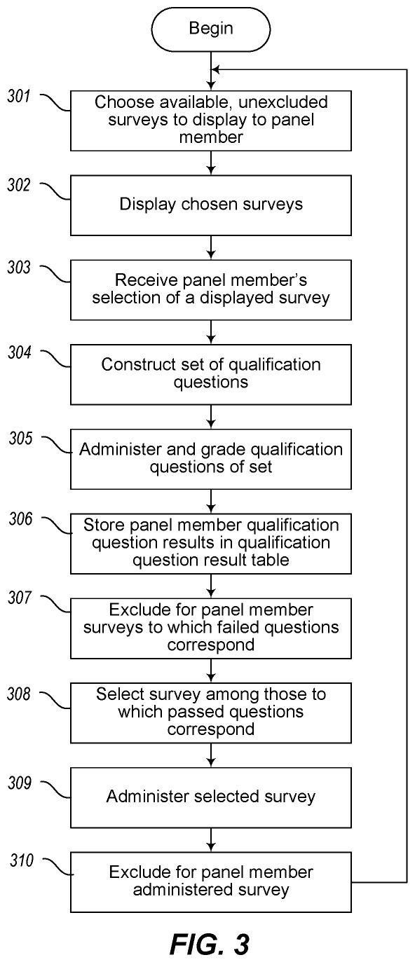

FIG. 3 is a flow diagram showing a process performed by the facility in some embodiments to administer surveys to a panel member. In act 301, the facility chooses available surveys from which the panel member has not been excluded to display to the panel member.

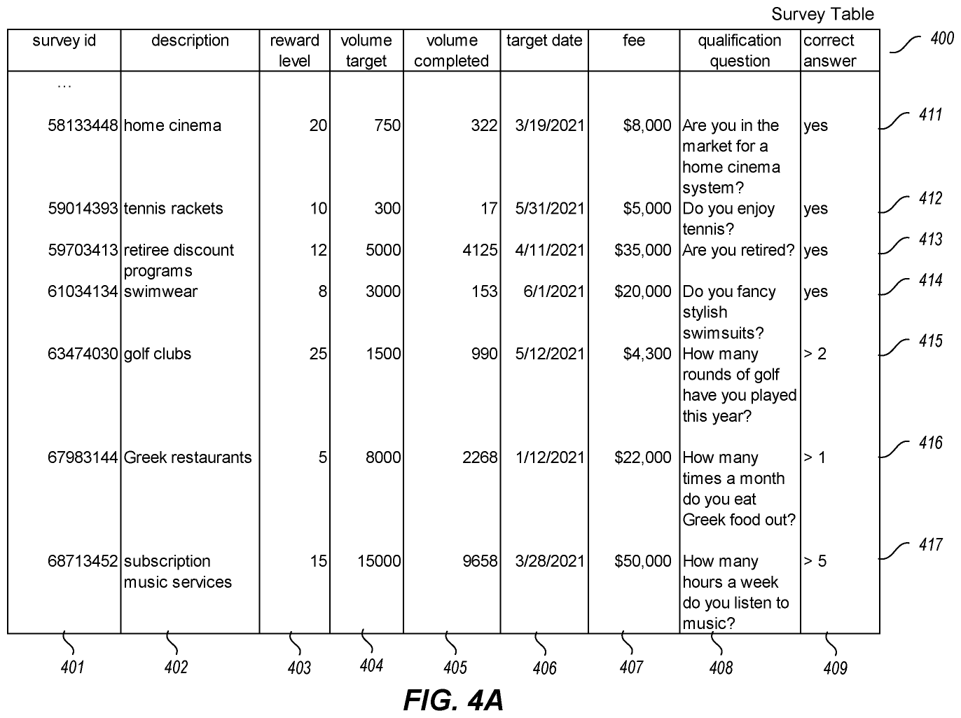

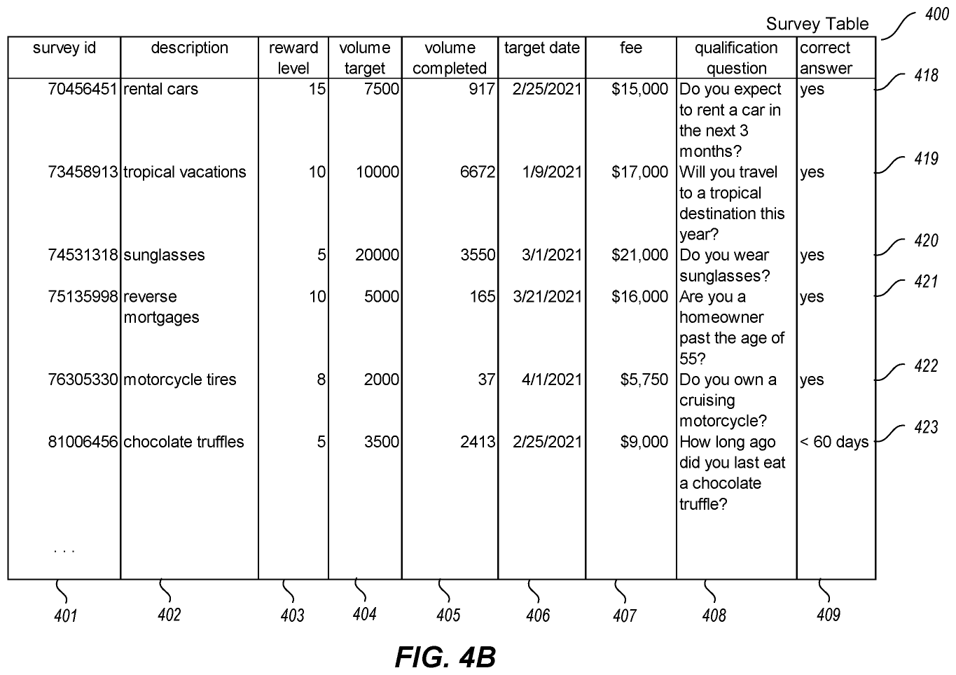

FIGS. 4A and 4B are table diagrams showing sample contents of a survey table used by the facility in some embodiments used to store information about active surveys placed on the survey platform. The survey table 400 is made up of rows, such as rows 411-423, each corresponding to a different survey that is active in the survey platform. Each row is divided into the following columns: a survey id column 401 uniquely identifying the survey to which the row corresponds; a description column 402 containing text describing the survey; a reward level column 403 indicating an amount of money, credit, or other reward that panel members will receive for taking the survey; a volume target column 404 indicating the number of panel members that the company placing the survey on the platform is seeking to have take the survey; a volume completed column 405 indicating the number of panel members who have taken the survey; a target date column 406 identifying the date by which the survey is to have been administered to the volume target number of panel members; a fee column 407 indicating the price that was paid in connection with the placement of the survey; a qualification question column 408 containing a question that is to be presented to panel members to determine whether they are qualified to take the survey; and a correct answer column 409 indicating the correct answer to the qualification question. For example, row 411 indicates that a “home cinema” survey with survey id 58133448 has a reward level of 20 credits, has been taken by 322 panelists out of a target of 750, is scheduled to be completed by Mar. 19, 2021, is the subject of an $8,000.00 fee, and has a qualification question of “Are you in the market for a home cinema system?” with a correct answer of “Yes.”

While FIGS. 4A-4B and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

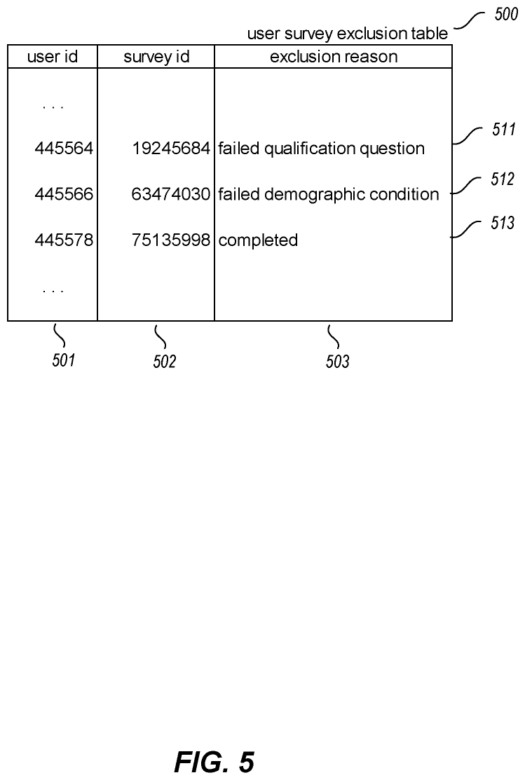

In some embodiments, the facility performs act 301 by randomly choosing a number of the surveys in the survey table that have not been excluded for the panel member. FIG. 5 is a table diagram showing sample contents of a user survey exclusion table used by the facility in some embodiments to identify surveys from which particular panel members are excluded. The user survey exclusion table 500 is made up of rows, such as rows 511-513, each corresponding to a particular panel member and one survey from which they are excluded. Each row is divided into the following columns: a user id column 501 identifying the panel member by their user id, a survey id column 502 identifying a survey from which the panel member is excluded; and an exclusion reason column 503 indicating a reason for which the panel member is excluded from the survey. For example, row 511 indicates that the panel member having user id 445564 is disqualified from the survey having survey id 19245684 because this panel member failed the qualification question specified for the survey. Row 512 indicates that the panel member having user id 445566—who is the primary subject of this example as it continues—has been excluded from the survey having survey id 63474030 because their demographic information does not satisfy a demographic condition specified for the survey. Such demographic conditions can be specified with regard to any demographic attributes of the panel members, such as age, sex, geographic location, occupation, income level, political or religious affiliation, etc. Also, row 513 indicates that the panel member having user id 445578 is excluded from the survey having survey id 75135998 because this panel member has already completed this survey.

Returning to FIGS. 4A and 4B, in performing act 301 on behalf of the audience member user id 445566, the facility randomly selects eight of rows 411-423 in survey table 400, excluding the survey in row 415, which is the survey from which this panel member is excluded by row 512 in user survey exclusion table 500. The facility randomly selects rows 411, 414, 416, 417, and 419-422.

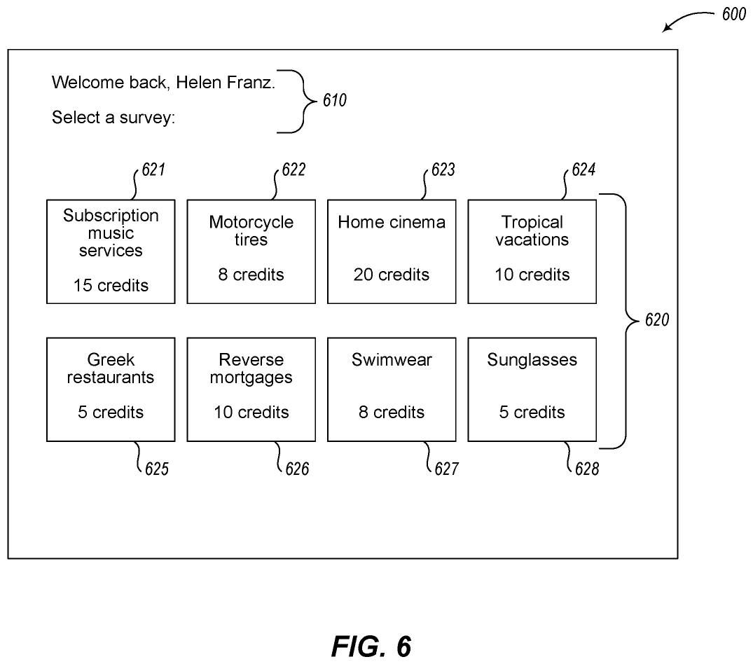

Returning to FIG. 3, in act 302, the facility displays the surveys chosen in act 301 to the panel member. FIG. 6 is a display diagram showing a sample display presented by the facility in some embodiments to permit a panel member to select an available, unexcluded survey. The display 600 includes a message 610 directing the panel member to select a survey. It further contains a number of tiles 620 each corresponding to a different survey. In particular, each tile contains a name or description of the survey, as well as reward level at which the panel member will be compensated if they complete the survey. For example, tile 621 represents a “Subscription music services” survey, which has a survey id of 68713452, and a reward level of 15 credits corresponding to row 417 of the survey table 400. In some embodiments (not shown), the survey tiles contain only information that does not give away the subject of the survey, in order to avoid bias that might result from panel members selecting the subject matter of their surveys.

Returning to FIG. 3, in act 303, the facility receives the panel member's selection of a displayed survey. In the example, the panel member selects tile 621 for the subscription music services survey.

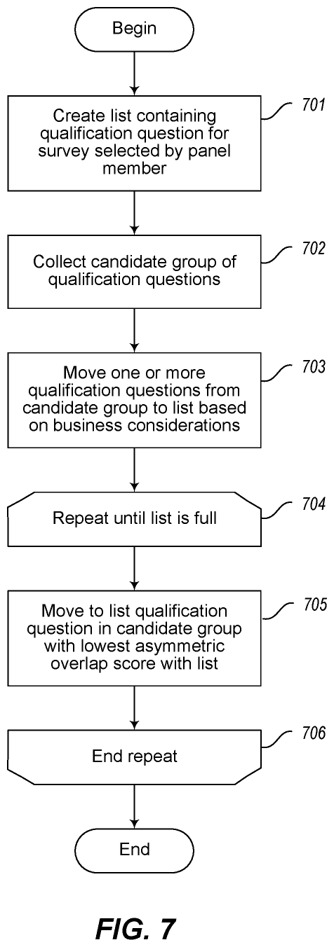

In act 304, the facility constructs a set of qualification questions to pose to the panel member in response to the panel member's selection of this survey. Details of the facility's performance of act 304 are discussed below in connection with FIG. 7.

FIG. 7 is a flow diagram showing a process performed by the facility in some embodiments to construct a set of qualifications based upon a particular panel member's selection of a particular survey. In act 701, the facility creates a list of qualification questions containing only the qualification question for the survey selected by the panel member. In the example, in act 701, the facility creates a list of qualification questions containing only the qualification question for the “Subscription music services” survey selected by the panel member, “How many hours a week do you listen to music?” (as shown in row 417 of FIG. 4A). In act 702, the facility collects a candidate group of qualification questions from among the available qualification questions in the survey table. In various embodiments, this collection omits surveys for various reasons, including: the survey is the one already selected by the audience member, and its qualification question is already in the list; the survey has demographic conditions not satisfied by the audience member; the audience member has already completed the survey; the audience member has answered the survey's qualification question incorrectly; etc. In some embodiments, where the survey table contains a large number of active surveys, the facility randomly selects a subset of eligible surveys from which to collect the candidate group of qualification questions; selects a subset of eligible surveys with the earliest target dates, or other compelling business considerations such as those discussed below in connection with step 703; etc.

In act 703, the facility moves one or more qualification questions from the candidate group collected in act 702 to the list of qualification questions based upon business considerations. For example, in some embodiments, the facility moves one or more qualification questions on the basis that their surveys have the earliest target dates, such as a “tropical vacations” survey shown in row 419 of survey table 400, which has the earliest target date among those shown in FIGS. 4A and 4B. In some embodiments, the facility includes in these business considerations the fee that has been or will be paid by the client for the completion of each survey, either (1) in its total amount, (2) distributed over the size of its volume target, or (3) distributed across the size of the unfulfilled portion of its volume target. In some embodiments, the facility includes among the business considerations the number or percentage of completions remaining for each survey. In some embodiments, the facility considers among the business considerations the reward level of each survey. In some embodiments, the facility considers among the business considerations how well-suited the panelist is to each survey, such as having a particular expertise, body of knowledge, or level of experience relevant to certain surveys. In some embodiments, the facility considers among the business considerations how well-suited each survey is to the panelist, such having a length, subject matter, or reward type or amount favored by the panelist. Those skilled in the art will appreciate that additional business considerations may be used, either alone or in combination.

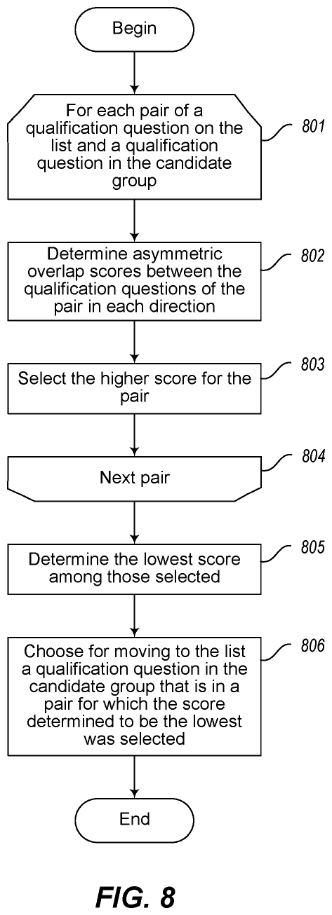

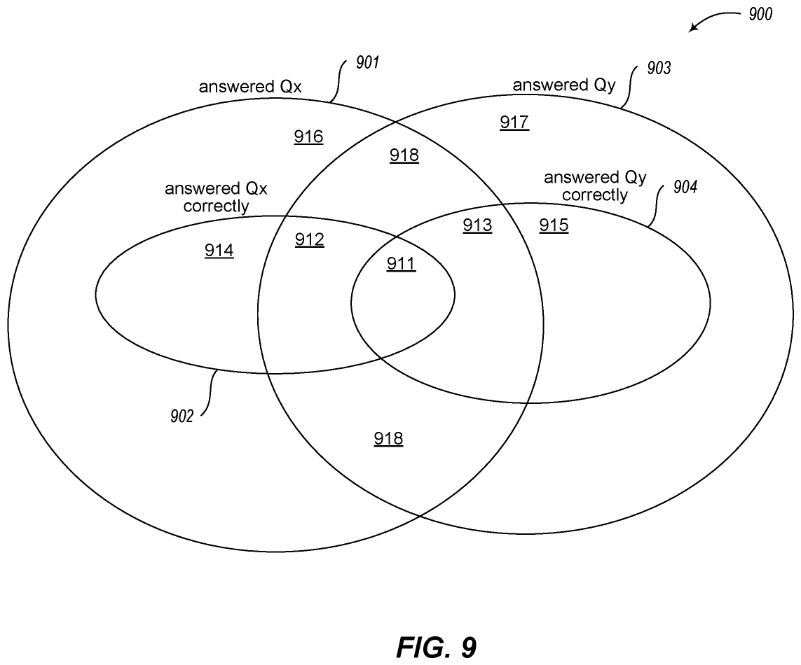

In acts 704-706, the facility repeats act 705 until the list of qualification questions is full—that is, the list contains a predetermined target number of qualification questions, such as seven. In act 705, the facility moves to the list of qualification questions the qualification question in the candidate group having the lowest asymmetric overlap score with the qualification questions already on the list. Additional details about the facility's performance of act 705 are discussed below in connection with FIGS. 8-9.

FIG. 8 is a flow diagram showing a process performed by the facility in some embodiments to identify the qualification question in the candidate group having the lowest asymmetric overlap score with the qualification questions already in the list. In acts 801-804, the facility loops through each pair of (1) a qualification question on the list, and (2) a qualification question in the candidate group. In act 802, the facility determines an asymmetric overlap score between the current pair of qualification questions in each direction. For a particular such pair of qualification questions Qx and Qy, the facility determines asymmetric overlap scores in each direction as discussed below in connection with Equations (1) and (2).

$${AO}_{Qx , Qy} = \frac{number of panel members answering Qx and Qy correctly}{number of panel members answering Qx correctly} \qquad ( 1 )$$

To determine asymmetric overlap between Qx and Qy in the Qx-to-Qy direction, the facility applies Equation (1) above. In particular, the facility divides the number of panel members answering both Qx and Qy correctly by the number of panel members answering Qx correctly. The two terms of this quotient are discussed below in connection with FIG. 9.

FIG. 9 is a Venn diagram showing all possible patterns of interaction of panel members with qualification questions Qx and Qy. Set 901 is all panel members that gave any answer to Qx. Among these is set 902 of all panel members who answered question Qx correctly. Similarly, set 903 is all of the panel members who gave any answer to question Qy, and set 904 is the panel members who gave the correct answer to question Qy. The intersection among the four sets mentioned above are labeled with reference numbers 911-918. In terms of the Venn diagram, the numerator of Equation (1) is region 911, the intersection between sets 902 and 904. The denominator is set 902, the sum of regions 911, 912, and 914.

$${AO}_{Qy , Qx} = \frac{number of panel members answering Qx and Qy correctly}{number of panel members answering Qy correctly} \qquad ( 2 )$$

The facility applies Equation (2) above to determine the asymmetric overlap between questions Qx and Qy in the Qy-to-Qx direction. This is the number of panel members answering both question Qx and question Qy correctly—the same numerator as in Equation (1)—divided by the number of panel members answering question Qy correctly. In terms of Venn diagram 900 in FIG. 9, the numerator of Equation (2) is region 911, the intersection of sets 902 and 904. The denominator is set 904, the sum of regions 911, 913, and 915.

Returning to FIG. 8, in some embodiments, the facility caches some or all of the asymmetric overlap scores, such that, for some or all asymmetric overlap scores, they are retrieved rather than calculated in act 802. In various embodiments, the facility calculates the cached asymmetric overlap scores either in earlier iterations of act 802, or in a separate, comprehensive asymmetric overlap score calculation process (not shown). In some embodiments, the facility maintains the cached asymmetric overlap scores in a table, such as a qualification question correlation table.

In act 803, the facility selects the higher score for the pair, that is, max(AO_{Qx,Qy}, AO_{Qy,Qx}). In some embodiments, the facility caches the selected score of the pair for use in future iterations of act 803 (not shown). In act 804, if additional pairs remain to be processed, the facility continues in act 801, else the facility continues in act 805. In act 805, the facility determines the lowest asymmetric overlap score among those selected in act 803. In act 806, the facility chooses for moving from the candidate group to the list one or more qualification questions for which the lowest score determined in act 805 was selected in act 803. After act 806, this process concludes.

In some embodiments, where the number of joint observations (in terms of the Venn diagram, the intersection of sets 901 and 903, equal to the sum of regions 911, 912, 913, and 918) for question Qx and question Qy is below some threshold, such as 10, then the facility assigns an asymmetric overlap score of zero to this pair of questions, without performing the calculations specified in Equations (1) and (2) above. In some embodiments, if a particular question has been answered less than a threshold number of times, such as thirty (for question Qx, set 901, equal to the sum of regions 911, 912, 913, 914, 916, and 918), then the facility assigns an asymmetric overlap score of zero to all pairs of questions containing this question, without performing the calculations specified in Equations (1) and (2) above.

In some embodiments, the facility limits the panel member answers to qualification questions that it considers in calculating asymmetric overlap in one or more dimensions. In some embodiments, the facility limits the answers to questions it considers in calculating asymmetric overlap to those panel members in the same demographic group or other audience segment as the audience member for whom asymmetric overlap is being calculated. In some embodiments, the facility considers answers to questions that have been received recently from audience members, such as within a predetermined period of time of the present, or a certain number of the most recent question responses. In various such embodiments, the facility considers the time at which audience members answered a particular one of the two questions; an average time among the times at which each audience member answered the two questions; an earliest or latest time among these two times; etc.

Those skilled in the art will appreciate that the acts shown in FIG. 8 and in each of the flow diagrams discussed herein may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

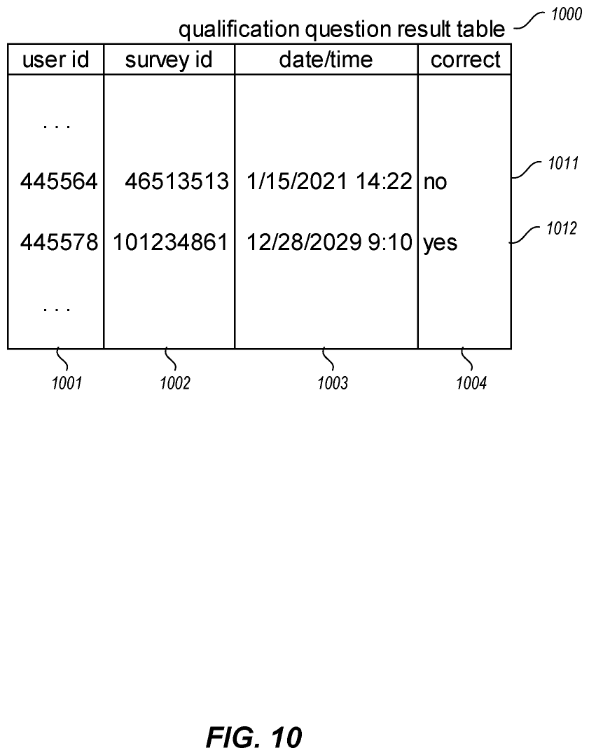

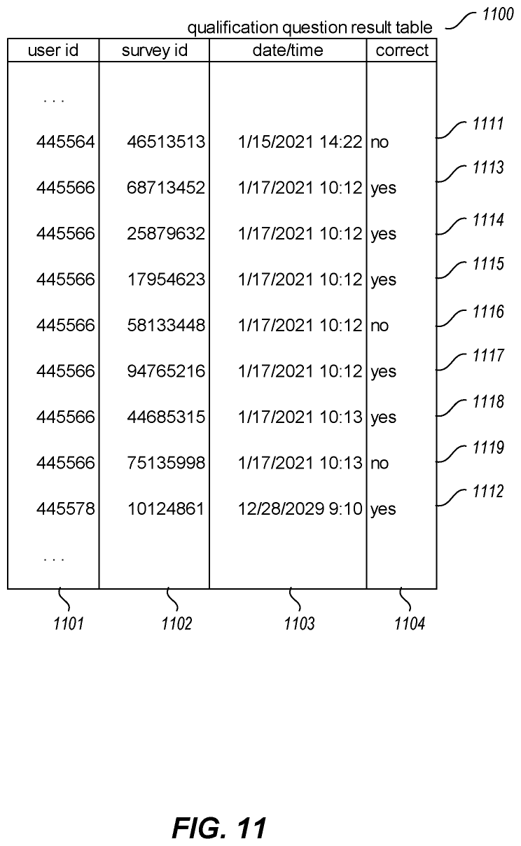

Returning to FIG. 3, in act 305, the facility administers and grades the set of qualification questions constructed in act 304. In act 306, the facility stores a panel member's qualification question results in a qualification question result table. FIGS. 10 and 11 illustrate this process.

FIG. 10 is a table diagram showing initial sample contents of a qualification question result table used by the facility in some embodiments to store the results of administering particular qualification questions to particular audience members. The qualification question result table 1000 is made up of rows such as rows 1011 and 1012, each corresponding to the combination of a particular panel member and a qualification question that the panel member has answered. Each row is divided into the following columns: User id column 1001 containing the user id identifying the panel member; a survey id column 1002 containing a survey id identifying in the survey whose qualification question was administered; a date/time column 1003 identifying the date and time at which an answer to the qualification question was received from the panel member; and a correct column 1004 containing an indication of whether the answer received as correct. For example, 1011 indicates that a panel member having user id 445564 answered the qualification for the survey having survey id 46513513 on Jan. 15, 2021 at 2:22 pm, and answered it incorrectly.

FIG. 11 is a table diagram showing subsequent sample contents of the qualification question result table. The contents of table 1100 reflect the administration of seven qualification questions to the panel member who is the subject of the example, who has user id 445566. Comparing table 1100 to table 1000, it can be seen that the facility has added rows 1113-1119, each corresponding to one of the qualification questions administered to the panel member in the example after selecting the subscription music services survey. From rows 1113, 1114, 1115, 1117, and 1118, it can be seen that this panel member correctly answered the qualification questions for the surveys having survey ids 68713452, 25879632, 17954623, 94765216, and 44685315, respectively. New rows 1116 and 1119, on the other hand, identify surveys whose qualification questions the panel member answered incorrectly.

Returning to FIG. 3, in act 307, the facility excludes for this panel member each of the surveys whose qualification questions the panel member answered incorrectly.

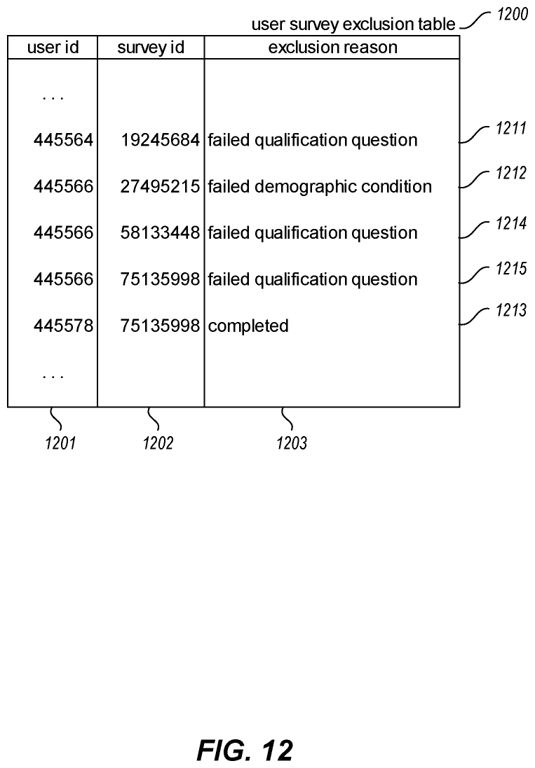

FIG. 12 is a table diagram showing subsequent sample contents of the user survey exclusion table, as updated to reflect qualification questions answered incorrectly by the panel member in the example. By comparing table 1200 to table 500 discussed above, it can be seen that the facility has added rows 1214 and 1215 for the panel member in the example, who has user id 445566. These new rows of the user survey exclusion table correspond to rows 1116 and 1119 of the qualification question result table shown in FIG. 11.

Returning to FIG. 3, in act 308, the facility selects a survey among those to which the correctly-answered qualification questions correspond. In various embodiments, the facility performs act 308 by selecting one of the surveys randomly; selecting the one of the surveys whose qualification question was added to the qualification list the earliest; selecting one of the surveys on the basis of business factors such as those discussed above in connection with act 703 discussed above; etc. In the example, the facility selects for administration the subscription movie services survey that was chosen by the panel member, and accordingly was the first survey added to the list of qualification questions. In act 309, the facility administers the selected survey. In some embodiments, this involves displaying a sequence of questions, permitting the panel member to provide an answer or other response to each of the questions; recording these responses; and performing various forms of post-processing on these responses. In act 310, the facility excludes for this panel member the survey administered in act 309. After act 310, the facility continues in act 301 to choose and display another set of available, unexcluded surveys to the panel member.

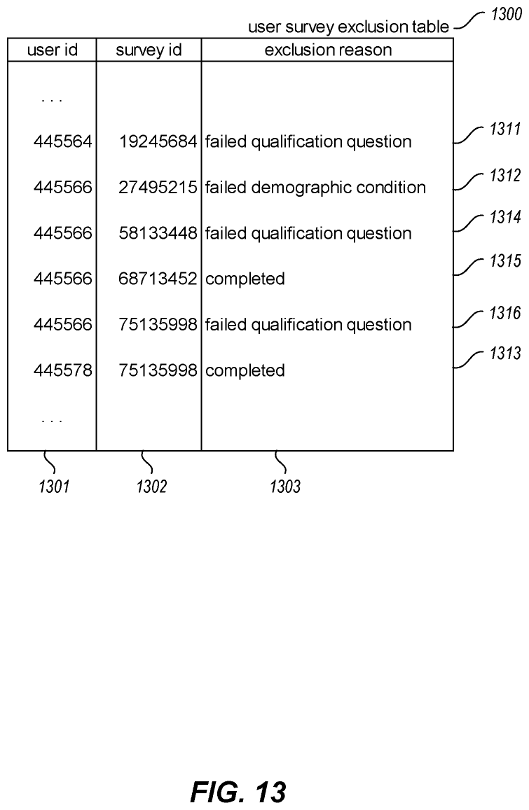

FIG. 13 is a table diagram showing subsequent sample contents of the user survey exclusion table, updated to exclude the administered survey for the panel member in the example. By comparing table 1300 to table 1200 shown in FIG. 12, it can be seen that the facility has added row 1315, indicating that this user has completed the subscription music services survey having survey id 68713452.

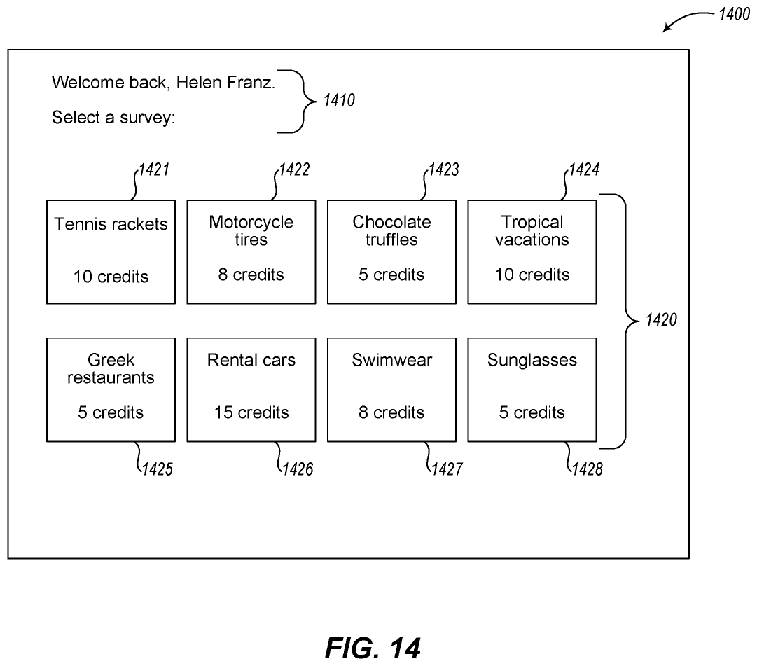

FIG. 14 is a display diagram showing subsequent sample contents of the display presented by the facility to permit a panel member to select an available, unexcluded survey. By comparing display 1400 to display 600 shown in FIG. 6 and discussed above, it can be seen that the facility has replaced tile 621 for the subscription music services survey, which the audience member completed, with tile 1421 for a tennis rackets survey; replaced tile 623 for the home cinema survey whose qualification question the user answered incorrectly with tile 1423 for a chocolate truffles survey; and replaced tile 626 for the reverse mortgages survey, whose qualification question the panel member answered incorrectly, with tile 1426 for a rental cars survey.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system, the method comprising:
receiving input originated by a user choosing an available survey;
assembling a list of survey qualification questions, comprising:
a qualification question for the chosen survey;
one or more qualification questions each for a survey identified on the basis of one or more business factors; and
two or more qualification questions having the lowest asymmetric overlap with qualification questions on the list;
causing the qualification questions on the list to be presented to the user;
receiving responses to the presented qualification questions originated by the user;
for each of the presented qualification questions, determining whether the received response correctly answers the question; and
selecting for administration to the user a survey corresponding to one of the presented qualification questions determined to be answered correctly.

2. The method of claim 1, further comprising administering the selected survey.

3. The method of claim 1 wherein the selected survey is different from the chosen survey.

4. The method of claim 1, further comprising:
adding the surveys whose qualification questions were determined to be answered incorrectly to a set of surveys excluded for the user,
and wherein no survey qualification questions for the surveys in the set of surveys excluded for the user are added to the assembled list of survey qualification questions.

5. The method of claim 1, further comprising:
for each of set of candidate qualification questions:
for each of the qualification questions already on the list:
to obtain the asymmetric overlap for the candidate qualification question and the qualification question, determining a maximum among:
a number of users who have answered correctly both the candidate qualification question and the qualification question already on the list, divided by a number of users who have answered correctly the candidate qualification question, and
a number of users who have answered correctly both the candidate qualification question and the qualification question already on the list, divided by a number of users who have answered correctly the qualification question already on the list.

6. The method of claim 1 wherein the one or more business factors comprise target dates for completing administration of the surveys.

7. The method of claim 1 wherein the one or more business factors comprise target dates for completing administration of the surveys each divided by a target number of remaining completions of the survey.

8. The method of claim 1 wherein the one or more business factors comprise prices charged for the surveys each divided by a target number of remaining completions of the survey.

9. The method of claim 1 wherein the one or more business factors comprise prices charged for the surveys each divided by a total target number of completions of the survey.

10. One or more computer memories collectively storing a survey qualification question data structure, the data structure comprising:
for each of a plurality of candidate survey qualification questions,
for each of a plurality of survey qualification questions already selected for a distinguished user:
a value characterizing the extent to which correct user answers to the candidate survey qualification question correlate with user answers to the survey qualification question already selected for the distinguished user,
such that the contents of the data structure are usable to select an additional survey qualification question for the distinguished user from among the plurality of candidate survey qualification questions.

11. The one or more computer memories of claim 10 wherein the values exclude user answers to the candidate survey qualification questions and the survey qualification questions selected for the distinguished user that occurred before a threshold date/time.

12. The one or more computer memories of claim 10 wherein the values exclude user answers to the candidate survey qualification questions and the survey qualification questions selected for the distinguished user that occurred more than a specified amount of time in the past.

13. The one or more computer memories of claim 10 wherein the values include only user answers to the candidate survey qualification questions and the survey qualification questions selected for the distinguished user from users who share one or more predetermined demographic attributes with the distinguished user.

14. The one or more computer memories of claim 10, the data structure further comprising, for each of one or more additional users:
for each of a plurality of candidate survey qualification questions for the additional user,
for each of a plurality of survey qualification questions already selected for the additional user:
a value characterizing the extent to which correct user answers to the candidate survey qualification question correlate with user answers to the survey qualification question already selected for the additional user.

15. The one or more computer memories of claim 10 wherein a distinguished one of the values for a distinguished one of the candidate survey qualification questions and a distinguished one of the survey qualification questions already selected for the distinguished user is overridden to a predetermined value on the basis that (1) the distinguished candidate survey qualification question has a low level of incidence, (2) the distinguished survey qualification questions already selected for the distinguished user has a low level of incidence, or (3) both the distinguished candidate survey qualification question and the distinguished survey qualification questions already selected for the distinguished user have a low level of incidence.

16. The one or more computer memories of claim 10 wherein a distinguished one of the values for a distinguished one of the candidate survey qualification questions and a distinguished one of the survey qualification questions already selected for the distinguished user is overridden to a predetermined value on the basis that the distinguished candidate survey qualification question and the distinguished survey qualification questions already selected for the distinguished user have a low level of joint incidence.

17. One or more instances of computer-readable media collectively having contents configured to cause a computing system to perform a method, the method comprising:
(a) initializing a list of survey qualification questions to present to a distinguished user to be empty;
(b) adding to the initialized list a survey qualification question for a survey elected by the distinguished user;
(c) until the list reaches a predetermined size, repeating:
for each of a plurality of candidate survey qualification questions:
for each of the survey qualification questions on the list:
determining an asymmetric overlap score for the candidate survey qualification question with the survey qualification question on the list;
determining a lowest asymmetric overlap score among the determined asymmetric overlap scores;
moving one or more survey qualification questions from the plurality of candidate survey qualification questions to the list; and
(d) storing the list.

18. The one or more instances of computer-readable media of claim 17, further comprising:
causing the survey qualification questions in the list to be administered to the distinguished user.

19. The one or more instances of computer-readable media of claim 18, further comprising:
causing a survey to be administered to the distinguished user whose survey qualification question was answered correctly by the distinguished user.

20. The one or more instances of computer-readable media of claim 17, further comprising, before (c):
selecting one or more of the plurality of candidate survey qualification questions on the basis of business considerations; and
moving the selected survey qualification questions from the plurality of candidate survey qualification questions to the list.
